(19) United States
(12) Patent Application Publication
(10) Pub. No.: US 2025/0174743 A1
(43) Pub. Date: May 29, 2025

(54) METHOD OF DIAGNOSING OVERHEATING, OVERHEATING DIAGNOSIS APPARATUS AND BATTERY SYSTEM FOR PROVIDING THE METHOD

(71) Applicant: LG ENERGY SOLUTION, LTD., Seoul (KR)

(72) Inventor: Dong Hyun KIM, Daejeon (KR)

(73) Assignee: LG ENERGY SOLUTION, LTD., Seoul (KR)

(21) Appl. No.: 18/843,574

(22) PCT Filed: Jan. 27, 2023
(86) PCT No.: PCT/KR2023/001312

§ 371 Date: Sep. 3, 2024

(30) Foreign Application Priority Data
May 20, 2022 (KR) 10-2022-0061919

(51) Int. Cl. H01M 10/42; G01K 3/04; H01M 10/48

(52) U.S. Cl. CPC H01M 10/4285; G01K 3/04; H01M 10/486

(57) ABSTRACT

An overheating diagnosis method and an overheating diagnosis apparatus are discussed. The overheating diagnosing apparatus includes a measuring unit configured to measure a temperature of an object; a storage unit configured to store a plurality of temperature values measured by the measuring unit, and a control unit configured to, at each diagnosis time point of diagnosing overheating of the object, extract a plurality of previous diagnosis time points corresponding to a predetermined number of samples based on a respective diagnosis time point, calculate a moving average value that is an average of the plurality of temperature values corresponding to a plurality of diagnosis time points, respectively, and compare the temperature value measured at each diagnosis time point with a reference value equal to or greater than the moving average value by a predetermined value, to diagnose the overheating of the battery.

### TECHNICAL FIELD

### Cross-Reference to Related Application

This application claims priority to and the benefit of Korean Patent Application No. 10-2022-0061919 filed in the Korean Intellectual Property Office on May 20, 2022, the entire contents of which are incorporated herein by reference.

The present invention relates to a method of diagnosing overheating of an object (for example, a battery), an overheating diagnosis apparatus and a battery system providing the method.

### Background Art

Recently, as the demand for portable electronic products, such as notebooks, video cameras, and portable phones, has increased rapidly, and the development of electric vehicles, batteries for energy storage, robots, and satellites is in full swing, research on high-performance batteries capable of repeated charging and discharging is being actively conducted.

Currently commercialized secondary batteries include nickel cadmium batteries, nickel hydride batteries, nickel zinc batteries, lithium secondary batteries, and the like, and among them, the lithium secondary battery is in the spotlight for its advantages in that charge and discharge are free because a memory effect is little, a self-discharge rate is very low, and energy density is very high, compared to the nickel-based secondary battery.

On the other hand, the temperature of the battery is an important factor affecting the performance of the battery. In general, the battery can operate efficiently when the temperature of the battery is distributed at an appropriate temperature. For example, when the temperature of the battery is too high, the performance of the battery may be deteriorated or an accident, such as an explosion, may occur due to a decrease in the safety of a negative electrode crystal lattice of the battery. Therefore, it is necessary to accurately monitor the temperature of the battery.

In the related art, whether a battery is overheated is diagnosed by comparing a preset reference value with a measured temperature of the battery. The method in the related art has a problem in that it is difficult to take appropriate measures because the time interval between when the overheating event is diagnosed and when the battery explodes or the like occurs is too short. In addition, the method in the related art has a problem of erroneously diagnosing the temperature rise due to aging of the battery as an overheating event.

### DISCLOSURE

### Technical Problem

The present invention relates to an overheating diagnosis method capable of promptly diagnosing abnormal heating behavior (hereinafter, overheating) of an object with high precision, an overheat diagnosis apparatus and a battery system providing the method.

### Technical Solution

An overheating diagnosis apparatus according to one aspect of the present invention includes: a measuring unit configured to measure a temperature of an object; a storage unit configured to store a plurality of temperature values measured by the measuring unit; and a control unit configured to, at each diagnosis time point, extract a plurality of previous diagnosis time points corresponding to a predetermined number of samples based on a respective diagnosis time point, calculate a moving average value that is an average of the plurality of temperature values corresponding to a plurality of diagnosis time points, respectively, and compare a temperature value measured at each diagnosis time point with a reference value to diagnose the overheating of the object, wherein the reference value is equal to or greater than the moving average value by a predetermined value.

The control unit may calculate an average standard deviation value, which is an average of a plurality of standard deviations corresponding to the plurality of diagnosis time points, respectively, calculate a first error value by multiplying the average standard deviation value by a predetermined multiple, and calculate the reference value by adding the first error value to the moving average value.

When the average standard deviation value is less than a predetermined deviation reference value, the control unit may determine a predetermined correction value as a second error value and add the second error value to the moving average value to calculate the reference value.

When the measured temperature value exceeds the reference value, the control unit may diagnose that an overheating event has occurred in the object.

A battery system according to another aspect of the present invention includes: a battery including a plurality of battery cells; a measuring unit configured to measure a temperature of the battery; a storage unit configured to store a plurality of temperature values measured by the measuring unit, and a control unit configured to, at each diagnosis time point of diagnosing overheating of the battery, extract a plurality of previous diagnosis time points corresponding to a predetermined number of samples based on a respective diagnosis time point, calculate a moving average value that is an average of the plurality of temperature values corresponding to a plurality of diagnosis time points, respectively, and compare a temperature value measured at each diagnosis time point with a reference value equal to or greater than the moving average value by a predetermined value, to diagnose the overheating of the battery.

The control unit may calculate an average standard deviation value, which is an average of a plurality of standard deviations corresponding to the plurality of diagnosis time points, respectively, calculate a first error value by multiplying the average standard deviation value by a predetermined multiple, and calculate the reference value by adding the first error value to the moving average value.

When the average standard deviation value is less than a predetermined deviation reference value, the control unit may determine a predetermined correction value as a second error value and add the second error value to the moving average value to calculate the reference value.

When the measured temperature value exceeds the reference value, the control unit may diagnose that an overheating event has occurred in the battery.

An overheating diagnosis method according to still another aspect of the present invention includes: a temperature data collection operation of collecting a temperature value, which is a temperature measurement value of a battery, at a predetermined diagnosis time point for diagnosing overheating of the battery including a plurality of battery cells; a sample group determination operation of extracting a plurality of previous diagnosis time points corresponding to a number of samples based on the diagnosis time point; a reference value determination operation of calculating a moving average value, which is an average of a plurality of temperature values corresponding to a plurality of diagnosis time points, respectively, and a reference value equal to or greater than the moving average value by a predetermined value; and an overheat diagnosis operation of diagnosing the overheating of the battery by comparing the temperature value with the reference value.

The reference value determination operation may include calculating an average standard deviation value, which is an average of standard deviations corresponding to the plurality of diagnosis time points, respectively, calculating a first error value by multiplying the average standard deviation value by a predetermined multiple, and calculating the reference value by adding the first error value to the moving average value.

The reference value determination operation may include, when the average standard deviation value is less than a predetermined deviation reference value, determining a predetermined correction value as a second error value and adding the second error value to the moving average value to calculate the reference value.

The overheating diagnosis operation may include, when the measured temperature value exceeds the reference value, diagnosing that an overheating event has occurred in the battery.

### Advantageous Effects

Unlike the related art of diagnosis using a fixed reference value, the present invention calculates a reference value reflecting the temperature trend of an object at each overheating diagnosis time point and compares the calculated reference value with a measured temperature to perform an overheating diagnosis, thereby quickly determining the occurrence of an overheating event.

The present invention calculates a reference value reflecting the temperature trend of an object at each overheating diagnosis time point and compares the calculated reference value with the measured temperature to perform overheating diagnosis, so that it is possible to prevent a problem of erroneously diagnosing a rise in temperature due to aging of an object (for example, a battery) as the occurrence of an overheating event.

### DESCRIPTION OF THE DRAWINGS

FIG. 1 is a block diagram illustrating an overheating diagnosis apparatus according to an exemplary embodiment.

FIG. 2 is a block diagram illustrating a battery system according to another exemplary embodiment.

FIG. 3 is a flowchart illustrating an overheating diagnosis method according to an exemplary embodiment.

FIG. 4 is a flowchart illustrating a reference value determining operation S300 of FIG. 3 in detail.

FIG. 5 is an exemplary diagram illustrating a temperature change of a non-defective battery in a charging mode.

FIG. 6 is an exemplary diagram illustrating an overheating diagnosis for a defective battery in a charging mode.

### MODE FOR INVENTION

Hereinafter, an exemplary embodiment disclosed the present specification will be described in detail with reference to the accompanying drawings, and the same or similar constituent element is denoted by the same reference numeral regardless of a reference numeral, and a repeated description thereof will be omitted. Suffixes, “module” and and/or “unit” for a constituent element used for the description below are given or mixed in consideration of only easiness of the writing of the specification, and the suffix itself does not have a discriminated meaning or role. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

It should be understood that when one constituent element is referred to as being “coupled to” or “connected to” another constituent element, one constituent element can be directly coupled to or connected to the other constituent element, but intervening elements may also be present. By contrast, when one constituent element is referred to as being “directly coupled to” or “directly connected to” another constituent element, it should be understood that there are no intervening elements.

In the present application, it will be appreciated that terms “including” and “having” are intended to designate the existence of characteristics, numbers, operations, operations, constituent elements, and components described in the specification or a combination thereof, and do not exclude a possibility of the existence or addition of one or more other characteristics, numbers, operations, operations, constituent elements, and components, or a combination thereof in advance.

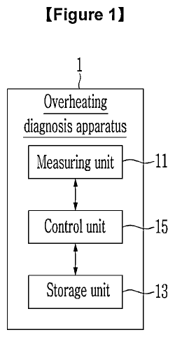

FIG. 1 is a block diagram illustrating an overheating diagnosis apparatus according to an exemplary embodiment.

Referring to FIG. 1, an overheating diagnosis apparatus 1 includes a measuring unit 11, a storage unit 13, and a control unit 150.

The measuring unit 11 may measure a temperature of an object at each diagnosis time point (hereinafter referred to as a diagnosis time point) for diagnosing overheating of the object, and transmit the measurement result to the control unit 15. For example, the measuring unit 11 may include a temperature sensor that measures the temperature of an object. In this case, the object may include, but is not limited to, a battery, and may include various devices that need to be predicted in advance before an overheating event occurs.

The storage unit 13 may store a temperature value of the object measured by the measuring unit 11 at each diagnosis time point. In addition, the storage unit 13 may store a moving average (MA) value, a standard deviation (SD), an average standard deviation (SD_ave), and a reference value (Th) calculated by the control unit 15 at each diagnosis time point. For example, the storage unit 13 may store the temperature value, moving average (MA) value, standard deviation (SD), average standard deviation (SD_ave), and reference value (Th) of the object corresponding to a predetermined diagnosis time point in the form of a lookup table.

The control unit 15 calculates a moving average value MA and a reference value Th greater than the moving average value by a predetermined value when a diagnosis time point according to a preset condition arrives. For example, when the object is a battery, the diagnosis time point may be a time point when charging of the battery starts or a time point when discharging of the battery ends. However, the present invention is not limited thereto, and the diagnosis time point may be variously set.

First, the control unit 15 may extract a plurality of diagnosis time points included in the preset number of samples SN when counting the diagnosis time points in the direction of the previous diagnosis time point based on the current diagnosis time point N, and determine a sample group. In this case, the number of samples SN is the number of a plurality of diagnosis time points included in the sample group, and may be determined as an optimal number based on an experiment or the like.

The sample group is a subgroup of a plurality of past diagnosis time points, which is a population, and may be a group for calculating a moving average MA and a average standard deviation value σ_ave, which will be described below.

TABLE 1

| | Diagnosis period | | | | | | | |
|---|---|---|---|---|---|---|---|---|
| | 1 | . . . | N-5 | N-4 | N-3 | N-2 | N-1 | N |
| Temperature (T) | — | . . . | 29.4 | 29.3 | 29.4 | 29.3 | 29.5 | T_{N} |
| Moving | — | . . . | 29.37 | 29.36 | 29.35 | 29.37 | 29.36 | MA_{N} |
| average (MA) | | | | | | | | |
| Standard | — | . . . | 0.0745 | 0.0744 | 0.0743 | 0.0744 | 0.0745 | SD_{N} |
| deviation (SD) | | | | | | | | |
| Average standard | — | . . . | 0.0740 | 0.0741 | 0.0740 | 0.0742 | 0.0742 | SD_{N-ave} |
| deviation (SD_ave) | | | | | | | | |
| Reference | — | . . . | 29.6 | 29.61 | 29.61 | 29.702 | 29.7 | Th_{N} |
| value (Th) | | | | | | | | |
| Diagnosis | — | — | Normal | Normal | Normal | Normal | Normal | — |
| result | | | | | | | | |

Table 1 is one example of the look-up tables for the object temperature T, moving average MA, standard deviation SD, average standard deviation SD_ave, and reference value Th corresponding to each of a plurality of diagnosis time points. Hereinafter, a method of calculating the reference value Th_{N} necessary for overheating diagnosis at the N^{th} diagnosis time point will be described in detail. Also, the number of samples SN is assumed to be 5.

For reference, since at an initial diagnosis time point 1 in Table 1, there is no previous diagnosis time point to form the sample group, it may be difficult to directly calculate the moving average MA, standard deviation SD, average standard deviation SD_ave, and reference value Th (therefore, the corresponding values in Table 1 are marked with blanks). In addition, since at predetermined diagnosis time points (for example, 2, 3, 4, and 5) adjacent to the first diagnosis time point 1, the number of a plurality of previous diagnosis time points to form the sample group is insufficient, it may be difficult to calculate the moving average MA, standard deviation SD, average standard deviation SD_ave, and reference value Th. In this case, the designer may provide the values averaged according to the experiment as the moving average MA, standard deviation SD, standard deviation SD_ave, and reference value Th at the initial diagnosis time point and the adjacent diagnosis time points (for example, 1, 2, 3, 4, and 5).

The control unit 15 may extract an N−1^{th} diagnosis time point, an N−2^{th} diagnosis time point, an N−3^{th} diagnosis time point, an N−4^{th} diagnosis time point, and an N−5^{th} diagnosis time point corresponding to 5, which is the number of samples SN when counting the diagnosis time points in the direction of the previous diagnosis time point based on the current diagnosis time point N, and determine a sample group.

The control unit 15 may determine a sample group by extracting the plurality of diagnosis time points N−1, N−2, N−3, N−4, and N−5, and determine a reference value used for defect diagnosis based on a temperature value measured at each of a plurality of diagnosis time points belonging to the sample group.

Then, for example, in the case where the object is a battery, when the battery is used for a considerable period of time, the internal resistance value increases due to aging, and the problem of misdiagnosing the temperature rise due to the increase in the internal resistance value as the occurrence of an overheating event may be prevented. In addition, it is possible to solve the problem of erroneously diagnosing a temporary temperature rise the occurrence of an overheating event.

Next, the control unit 15 determines a reference value Th_{N} corresponding to the N^{th} diagnosis time point based on the temperature value measured at each of the plurality of diagnosis time points N−1, N−2, N−3, N−4, and N−5 belonging to the sample group.

According to the embodiment, the control unit 15 compares the temperature value T_{N} measured at the N^{th} diagnosis time point with the reference value Th_{N} to diagnose whether the object is overheated. For example, referring to Table 1, the moving average value MA_{N} and the average standard deviation SD_{N}_ave are values required to calculate the reference value Th_{N}. However, the standard deviation SD_{N} is not a value necessary for diagnosing the overheating state at the N^{th} diagnosis time point, but is needed when the overheating state is diagnosed at the subsequent diagnosis time points N+1, N+2, . . . , so that the standard deviation SD_{N} may be calculated at the N^{th} diagnosis time point and stored in the storage unit 13.

Hereinafter, with reference to Table 1, the moving average value MA_{N}, standard deviation SD_{N}, average standard deviation SD_{N}_ave, and reference value Th_{N} calculated by the control unit 15 at the N^{th} diagnosis time pint will be described.

The control unit 15 may average (29.4° C.+29.3° C.+29.4° C.+29.3° C.+29.5° C./5=29.38° C.) the plurality of temperature values (29.4° C., 29.3° C., 29.4° C., 29.3° C., 29.5° C.) corresponding to the plurality of diagnosis time points (N−5, N−4, N−3, N−2, and N−1), respectively, belonging to the sample group and calculate the moving average value MA_{N} (29.38° C.) corresponding to the diagnosis time point N. That is, when it is assumed that the number of samples SN is 5, the moving average value MA_{N} at the N^{th} diagnosis time point may be calculated by Equation (1) below.

$$M {A}_{N} = \frac{{T}_{N - S} + {T}_{N - 4} + {T}_{N - 3} + {T}_{N - 2} + {T}_{N - 1}}{5} \qquad Equation ( 1 )$$

Referring to Table 2 below, the control unit 15 may calculate a standard deviation SD_{N} corresponding to the N^{th} diagnosis time point based on the temperature values T and the moving average values MA_{N} corresponding to the plurality of diagnosis time points N−5, N−4, N−3, N−2, and N−1, respectively, belonging to the sample group calculated by using above Equation (1).

TABLE 2

| | N-5 | N-4 | N-3 | N-2 | N-1 | N |
|---|---|---|---|---|---|---|
| Temperature (T) | 29.4 | 29.3 | 29.4 | 29.3 | 29.5 | |
| \|T-MAₙ\| | \|29.4-29.38\| | \|29.3-29.38\| | \|29.4-29.38\| | \|29.3-29.38\| | \|29.5-29.38\| | |
| (T-MAₙ)² | (0.02)² = | (0.08)² = | (0.02)² = | (0.08)² = | (0.12)² = | |
| | 0.0004 | 0.0064 | 0.0004 | 0.0064 | 0.0144 | |
| Dispersion | (0.0004 + 0.0064 + 0.0004 + 0.0064 + 0.0144)/5 = 0.0056 | | | | | |
| Standard | \sqrt{0.0056} = 0.0748331477(≈0.0748) | | | | | 0.0748 |
| deviation (SD_{N}) | | | | | | |

As described above, the standard deviation SD_{N} corresponding to the N^{th} diagnosis time point is not a value necessary for diagnosing an overheating state at the N^{th} diagnosis time point, but is required for diagnosing whether the object is overheated at the next diagnosis time point N+1, N+2, and . . . . Accordingly, the standard deviation SD_{N} corresponding to the N^{th} diagnosis time point may be calculated at the N^{th} diagnosis time point and stored in the storage unit 13.

TABLE 3

| | N-5 | N-4 | N-3 | N-2 | N-1 | N |
|---|---|---|---|---|---|---|
| Standard | 0.0740 | 0.0742 | 0.0740 | 0.0742 | 0.0746 | |
| deviation (SD) | | | | | | |
| Average standard | (0.0740 + 0.0742 + 0.0740 + 0.0742 + 0.0746)/5 = 0.0742 | | | | | 0.0742 |
| deviaton (SD_{N}_{_{—}}ₐᵥₑ) | | | | | | |

Referring to Table 3, the control unit 15 may calculate a average standard deviation value SD_{N}_ave (0.0742) corresponding to the N^{th} diagnosis time point based on a plurality of standard deviations SD_{N-5}, SD_{N-4}, SD_{N-3}, SD_{N-2}, and SD_{N-1} corresponding to the plurality of diagnosis time points N−5, N−4, N−3, N−2, and N−1, respectively, belonging to the sample group.

The control unit 15 may calculate a reference value Th having a predetermined value greater than the moving average value MA_{N}. According to the embodiment, the control unit 15 may calculate an error value ER obtained by multiplying the average standard deviation value SD_ave by a predetermined multiple Q, and calculate the reference value Th by adding the error value ER to the moving average value MA. In this case, the multiple Q is a value for setting a criterion for whether an overheating event occurs, and may be determined by various values through experiments. Hereinafter, it is assumed that the multiple Q is the natural number 3.

Temperature deviations of ±0.5° C. may occur according to a temperature sensor mounted on an overheating diagnosis apparatus to measure the temperature of an object, and the type of Analog-Digital Converter (ADC) that converts the measured analog temperature value into a digital temperature value, and the like. For precise overheating diagnosis of an object, it is necessary to compensate for a temperature deviation that may occur by a temperature sensor.

According to the embodiment, when the average standard deviation value SD_ave is equal to or greater than the predetermined deviation reference value Th__{DV}, the control unit 15 may calculate the error value ER by multiplying the average standard deviation value SD_ave by a predetermined multiple. In this case, the deviation reference value Th__{DV} may be a reference value for reflecting an error that may occur in a temperature measurement process. For example, the deviation reference value Th__{DV} may be set to 0.5° C., but is not limited thereto, and may be determined to various values according to experiments.

When the average standard deviation value SD_ave is equal to or greater than the predetermined deviation reference value Th__{DV}, the control unit 15 may calculate the error value ER using Equation (2) below.

$$E R = {SD\_}_{ave} \times Q \qquad Equation ( 2 )$$

According to another embodiment, when the average standard deviation value SD_ave is less than the predetermined deviation reference value Th__{DV}, the control unit 15 may determine the predetermined correction value CB as the error value ER. In this case, the correction value CB may be a value for correcting an error that may occur in a temperature measurement process. For example, the correction value CB may be set to 0.5° C., but is not limited thereto, and may be determined to various values according to experiments.

$$ER = CB \qquad Equation ( 3 )$$

$$ER = CB$$

For example, referring to Table 3, the average standard deviation value SD_{N}_ave corresponding to the N^{th} diagnosis time point may be calculated as 0.0742. That is, since the average standard deviation value SD_{N}_ave (0.0742) corresponding to the N^{th} diagnosis time point is less than the predetermined deviation reference value Th__{DV} (0.5) (0.0742<0.5), the control unit 15 may determine the predetermined correction value CB (0.5) as the error value ER.

The control unit 15 may calculate the reference value Th by adding the error value ER to the moving average value MA. For example, when the average standard deviation value SD_ave is equal to or greater than the predetermined deviation reference value Th__{DV}, the control unit 15 may calculate the error value ER by multiplying the average standard deviation value SD_ave by a predetermined multiple, and calculate the reference value Th by adding the error value ER to the moving average value MA. For another example, when the average standard deviation value SD_ave is less than the predetermined deviation reference value Th__{DV}, the control unit 15 may determine the correction value CB as the error value ER and calculate the reference value Th by adding the error value ER to the moving average value MA. The control unit 15 may calculate the reference value Th by using Equation (4) below.

$$Th = MA + ER \qquad Equation ( 4 )$$

For example, referring to Table 3 above, since the average standard deviation value SD_{N}_ave (0.0742) corresponding to the N^{th} diagnosis time point is smaller than the deviation reference value Th__{DV} (0.5), the control unit 15 may determine a predetermined correction value CB (0.5) as an error value ER. The control unit 15 may calculate the reference value Th by adding the error value ER (0.5° C.) to the moving average value MA (29.38). That is, the reference value Th may be 29.88° C. (29.38° C.+0.5° C.).

The control unit 15 may compare the temperature T_{N} value measured at the N^{th} diagnosis time point with the reference value Th_{N} calculated at the N^{th} diagnosis time point to diagnose whether an overheating event has occurred in the object.

For example, referring to Table 1, it is assumed that the temperature T_{N} value measured at the N^{th} diagnosis time point is 30° C. Since the value of temperature T_{N} (30° C.) corresponding to the N^{th} diagnosis time point exceeds the reference value Th_{N} (29.88° C.) corresponding to the N^{th} diagnosis time point, the control unit 35 may diagnose that an overheating event has occurred.

TABLE 4

| | Diagnosis period | | | | | | | | |
|---|---|---|---|---|---|---|---|---|---|
| | 1 | . . . | N-5 | N-4 | N-3 | N-2 | N-1 | N | N + 1 |
| Temperature (T) | — | | 29.4 | 29.3 | 29.4 | 29.3 | 29.5 | 30 | T_{N+1} |
| Moving | — | | 29.37 | 29.36 | 29.35 | 29.37 | 29.36 | 29.38 | MA_{N+1} |
| average (MA) | | | | | | | | | |
| Standard | — | | 0.0745 | 0.0744 | 0.0743 | 0.0744 | 0.0745 | 0.0748 | SD_{N+1} |
| deviation (SD) | | | | | | | | | |
| Average standard | — | | 0.0740 | 0.0741 | 0.0740 | 0.0742 | 0.0742 | 0.0742 | SD_{N+1}_{_{—}}ₐᵥₑ |
| deviation (SD_ave) | | | | | | | | | |
| Reference | — | | 29.6 | 29.61 | 29.61 | 29.702 | 29.7 | 29.88 | Th_{N+1} |
| value (Th) | | | | | | | | | |
| Diagnosis result | — | | Normal | Normal | Normal | Normal | Normal | Overheating | — |

Table 4 is another example of a lookup table for the temperature T, moving average MA, standard deviation SD, average standard deviation (SD_ave), and reference value Th of the object corresponding to each of a plurality of diagnosis time points.

Referring to Table 4, when the control unit 15 may extract an N^{th} diagnosis time point, an N−1^{th} diagnosis time point, an N−2^{th} diagnosis time point, an N−3^{th} diagnosis time point, and an N−4^{th} diagnosis time point corresponding to the number of samples SN of 5 when counting the diagnosis time point in the direction of the previous diagnosis time point based on the current diagnosis time point N+1, and determine the sample group.

The control unit 15 may determine a sample group by extracting a plurality of diagnosis time points N, N−1, N−2, N−3, and N−4, and determine a reference value used for defect diagnosis based on the temperature value measured at each of the plurality of diagnosis time points belonging to the sample group.

The control unit 15 may calculate the moving average MA_{N+1}, standard deviation SD_{N+1}, average standard deviation SD_{N+1}_ave, and reference value Th_{N+1} corresponding to the N+1th diagnosis time point by using Tables 1 to 3 and Equations (1) to (4) described above.

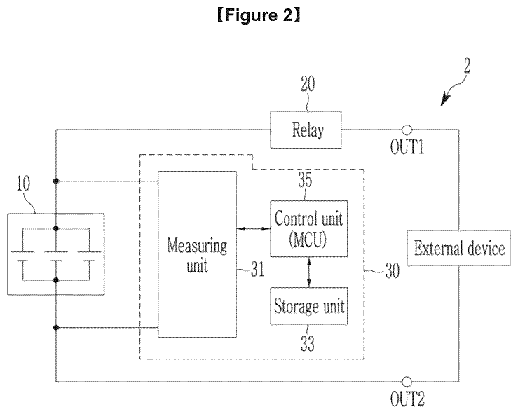

FIG. 2 is a block diagram illustrating a battery system according to another exemplary embodiment.

Referring to FIG. 2, a battery system 2 includes a battery 10, a relay 20, and a battery management system (BMS) 30.

The battery 10 may include a plurality of battery cells connected in series and/or in parallel. In FIG. 2, three battery cells connected in parallel are illustrated, but the present invention is not limited thereto, and the battery 10 may include various numbers of battery cells connected in series and/or in parallel. In some exemplary embodiments, the battery cell may be a rechargeable secondary battery. Further,

For example, in the battery 10, a predetermined number of battery cells is connected in parallel to form a battery bank, and a predetermined number of battery banks is connected in series to form a battery pack to supply desired power to an external device. For another example, in the battery 10, a predetermined number of battery cells is connected in parallel to form a battery bank, and a predetermined number of battery banks is connected in parallel to form a battery pack to supply desired power to an external device. However, the present invention is not limited to this connection, and the battery 10 may include a plurality of battery banks including a plurality of battery cells connected in series and/or parallel, and the plurality of battery banks may also be connected in series and/or parallel.

In FIG. 2, the battery 10 is connected between two output terminals OUT1 and OUT2 of the battery system 2. In addition, the relay 20 is connected between the positive electrode and the first output terminal OUT1 of the battery system 2. The configurations illustrated in FIG. 2 and the connection relationship between the configurations are examples, but the invention is not limited thereto.

The relay 20 controls electrical connection between the battery system 2 and an external device. When the relay 20 is turned on, the battery system 2 and the external device are electrically connected to perform charging or discharging, and when the relay 20 is turned off, the battery system 2 and the external device are electrically separated. In this case, the external device may be a charger in a charging cycle in which power is supplied to the battery 10 for charging, and may be a load in a discharging cycle in which the battery 10 discharges power to the external device.

The BMS 30 includes a measuring unit 31, a storage unit 33, and a control unit 35. The overheating diagnosis apparatus 1 illustrated in FIG. 1 may correspond to the BMS 30 illustrated in FIG. 2. Specifically, the functions performed by the measuring unit 11, the storage unit 13, and the control unit 15 of the overheating diagnosis apparatus 1 may correspond to the functions performed by the measuring unit 31, the storage unit 33, and the control unit 35 of the BMS 30. For example, the overheating diagnosis apparatus 1 may be configured separately from the battery system 2. For another example, in the battery system 2 as illustrated in FIG. 2, the BMS 30 may perform the function of the overheating diagnosis apparatus 1.

Hereinafter, descriptions of the respective functions of the measuring unit 31, the storage unit 33, and the control unit 35 of the BMS 30 will be replaced with the descriptions of the measuring unit 11, the storage unit 13, and the control unit 15 of the overheat diagnosis apparatus 1.

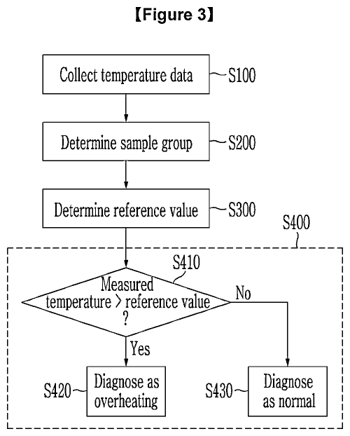

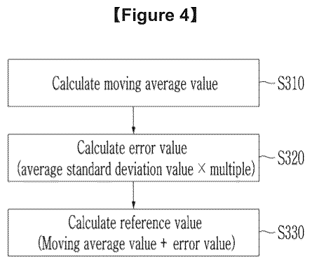

FIG. 3 is a flowchart illustrating an overheating diagnosis method according to an exemplary embodiment, and FIG. 4 is a flowchart illustrating a reference value determining operation S300 of FIG. 3 in detail.

Hereinafter, an overheating diagnosis method, the overheating diagnosis apparatus 1 and the battery system 2 for providing the overheating diagnosis method will be described with reference to FIGS. 1 to 4. Hereinafter, the overheating diagnosis method, the overheating diagnosis apparatus 1 and the battery system 2 for providing the overheating diagnosis method will be described based on the measuring unit 31, the storage unit 33, and the control unit 35 of the BMS 30 are described, but they may also be equally applied to the measuring unit 11, the storage unit 13, and the control unit 15 of the overheating diagnosis apparatus 1. In addition, although the present invention is described based on the battery 10, the present invention is not limited thereto, and may be equally applied to various objects requiring temperature measurement.

First, the control unit 35 collects the measurement value of the temperature of the battery 10 from the measuring unit 31 at a predetermined diagnosis time point for diagnosing overheating of the battery 10 (S100).

When a diagnosis time point according to a preset condition arrives, the measuring unit 31 may measure the temperature of the battery 10 and transmit the measurement result to the control unit 35. For example, the measuring unit 31 may include a temperature sensor to measure the temperature of the battery 10 at each diagnosis time point, and transmit the measurement result to the control unit 35. For another example, the measuring unit 31 may receive a temperature value measured by the temperature sensor at a predetermined time interval or in real time, extract temperature data corresponding to a predetermined diagnosis time point, and transmit the extracted temperature data to the control unit 35.

Next, the control unit 35 determines a sample group by extracting a plurality of previous diagnosis time points corresponding to the number of samples SN based on the current diagnosis time point N (S200).

### Table

Referring to Table 1, the control unit 35 may extract an N−1^{th} diagnosis time point, an N−2^{th} diagnosis time point, an N−3^{th} diagnosis time point, an N−4^{th} diagnosis time point, and an N−5^{th} diagnosis time point corresponding to 5, which is the number of samples SN when counting the diagnosis time points in the direction of the previous diagnosis time point based on the current diagnosis time point N, and determine a sample group.

The control unit 35 may determine a sample group by extracting the plurality of diagnosis time points N−1, N−2, N−3, N−4, and N−5, and determine a reference value TH_{N} used for defect diagnosis based on a temperature value measured at each of a plurality of diagnosis time points belonging to the sample group. When the reference value Th_{N} is set by a method to be described below, it is possible to prevent a problem of erroneously diagnosing an increase in temperature due to aging of the battery as an occurrence of an overheating event. In addition, it is possible to solve the problem of erroneously diagnosing a temporary temperature rise as occurrence of an overheating event.

Next, the control unit 35 determines the reference value Th_{N} corresponding to the N^{th} diagnosis time point based on the temperature value measured at each of the plurality of diagnosis time points N−1, N−2, N−3, N−4, and N−5 belonging to the sample group (S300).

In operation S300, referring to FIG. 4, the control unit 35 calculates a moving average value MA_{N} corresponding to the N^{th} diagnosis time point by averaging a plurality of temperature values corresponding to a plurality of diagnosis time points, respectively, belonging to the sample group (S310).

In particular, referring to Table 1, the control unit 35 may average (29.4° C.+29.3° C.+29.4° C.+29.3° C.+29.5° C./5=29.38° C.) the plurality of temperature values (29.4° C., 29.3° C., 29.4° C., 29.3° C., 29.5° C.) corresponding to the plurality of diagnosis time points (N−5, N−4, N−3, N−2, and N−1), respectively, belonging to the sample group and calculate the moving average value MA_{N} (29.38° C.) corresponding to the N^{th} diagnosis time point. That is, when it is assumed that the number of samples SN is 5, the moving average value MA_{N} at the N^{th} diagnosis time point may be calculated by Equation (1) above.

In operation S300, the control unit 35 calculates an average standard deviation value SD_{N}_ave by averaging a plurality of standard deviations corresponding to the plurality of diagnosis time points, respectively, belonging to the sample group, and calculates an error value based on the average standard deviation value SD_{N}_ave (S320).

In particular, referring to Table 3, the control unit 35 may calculate a average standard deviation value SD_{N}_ave (0.0742) corresponding to the N^{th} diagnosis time point based on a plurality of standard deviations SD_{N-5}, SD_{N-4}, SD_{N-3}, SD_{N-2}, and SD_{N-1} corresponding to the plurality of diagnosis time points N−5, N−4, N−3, N−2, and N−1, respectively, belonging to the sample group.

Temperature deviations of ±0.5° C. may occur according to a temperature sensor mounted on an overheating diagnosis apparatus to measure the temperature of an object, and the type of Analog-Digital Converter (ADC) that converts the measured analog temperature value into a digital temperature value, and the like. For precise overheating diagnosis of an object, it is necessary to compensate for a temperature deviation that may occur by a temperature sensor.

According to the embodiment, when the average standard deviation value SD_ave is equal to or greater than the predetermined deviation reference value Th__{DV}, the control unit 35 may calculate the error value ER by multiplying the average standard deviation value SD_ave by a predetermined multiple Q. In this case, the deviation reference value Th__{DV} may be a reference value for reflecting an error that may occur in a temperature measurement process. For example, the deviation reference value Th__{DV} may be set to 0.5, but is not limited thereto, and may be determined to various values according to experiments. Specifically, the control unit 35 may calculate the error value ER by using Equation (2).

According to another embodiment, when the average standard deviation value SD_ave is less than the predetermined deviation reference value Th__{DV}, the control unit 35 may determine a predetermined correction value CB as the error value ER. In this case, the correction value CB may be a value for correcting an error that may occur in a temperature measurement process. For example, the correction value CB may be set to 0.5° C., but is not limited thereto, and may be determined to various values according to experiments. Specifically, the control unit 35 may calculate the error value ER by using Equation (3).

For example, referring to Table 3, the control unit 35 may calculate the average standard deviation value SD_{N}_ave corresponding to the N^{th} diagnosis time point as 0.0742. In this case, since the average standard deviation value SD_{N}_ave (0.0742) corresponding to the N^{th} diagnosis time point is less than the predetermined deviation reference value Th__{DV} (0.5), the control unit 35 may determine the predetermined correction value CB (0.5) as the error value ER (0.5).

In operation S300, the control unit 35 may calculate the reference value Th by adding the error value ER to the moving average value MA (S330).

For example, when the average standard deviation value SD_ave is equal to or greater than the predetermined deviation reference value Th__{DV}, the control unit 35 may calculate the error value ER by multiplying the average standard deviation value SD_ave by a predetermined multiple, and calculate the reference value Th by adding the error value ER to the moving average value MA. For another example, when the average standard deviation value SD_ave is less than the predetermined deviation reference value Th__{DV}, the control unit 35 may determine the correction value CB as the error value ER and calculate the reference value Th by adding the error value ER to the moving average value MA. The control unit 35 may calculate the reference value Th by using Equation (4).

For example, referring to Table 3 above, since the average standard deviation value SD_{N}_ave (0.0742) corresponding to the N^{th} diagnosis time point is smaller than the deviation reference value Th__{DV} (0.5), the control unit 35 may determine a predetermined correction value CB (0.5) as an error value ER. The control unit 35 may calculate the reference value Th by adding the error value ER (0.5° C.) to the moving average value MA (29.38). That is, the reference value Th may be 29.88° C. (29.38° C.+0.5° C.).

Next, the control unit 35 may compare the temperature T_{N} value measured at the N^{th} diagnosis time point with the reference value Th_{N} calculated at the N^{th} diagnosis time point to diagnose whether an overheating event has occurred in the battery 10 (S400).

In operation S400, referring to FIG. 3, the control unit 35 determines whether the temperature T_{N} value corresponding to the N^{th} diagnosis time point exceeds the reference value Th_{N} (S410).

When the temperature T_{N} value corresponding to the N^{th} diagnosis time point exceeds the reference value Th_{N} as a result of the determination (S410, YES), the control unit 35 diagnoses that an overheating event has occurred in the battery 10 (S420).

For example, referring to Table 1, it is assumed that the temperature T_{N} value measured at the N^{th} diagnosis time point is 30° C. Since the value of temperature T_{N} (30° C.) corresponding to the N^{th} diagnosis time point exceeds the reference value Th_{N} (29.88° C.) corresponding to the N^{th} diagnosis time point, the control unit 35 may diagnose that an overheating event has occurred.

When the temperature T_{N} value corresponding to the N^{th} diagnosis time point does not exceed the reference value Th_{N} as the result of the determination (S410, NO), the control unit 35 diagnoses the temperature of the battery 10 as normal (S430).

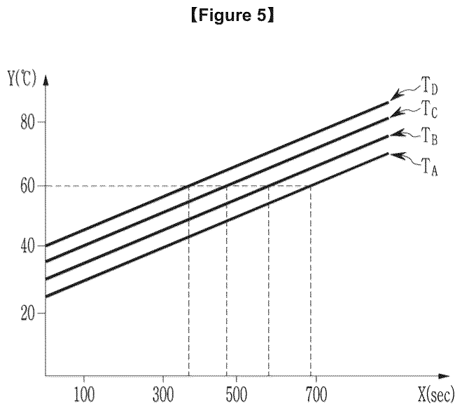

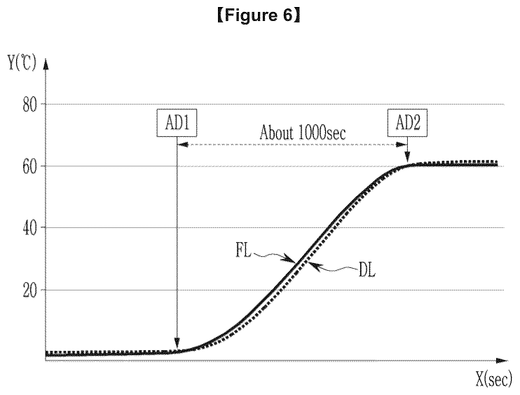

FIG. 5 is an exemplary diagram illustrating a temperature change of a non-defective battery in a charging mode, and FIG. 6 is an exemplary diagram illustrating an overheating diagnosis for a defective battery in a charging mode.

In FIGS. 5 and 6, the X-axis represents time (sec), and the Y-axis represents temperature (° C.).

Referring to FIG. 5, FIG. 5 is an exemplary diagram illustrating temperature change with respect to time change when a non-defective battery is charged at various external temperatures.

For example, when the ambient temperature is 25° C., in a charging mode in which the battery 10 is charged with power from an external device, the change in temperature of the battery 10 over time may correspond to a first graph T_{A}. For another example, when the ambient temperature is 30° C., when the battery 10 is charged, the change in temperature of the battery 10 over time may correspond to a second graph T_{B}. Equally, the temperature changes of the battery 10 when the ambient temperature is 35° C. and when the ambient temperature is 40° C. may correspond to a third graph T_{C} and a fourth graph T_{D}, respectively.

That is, in the case of the battery 10 in a normal state according to a predetermined criterion or a new unused battery 10, when the external temperature changes, the starting temperature value may be different, but as illustrated in FIG. 5, the temperature change (that is, a slope) according to a change in time may be constant.

Referring to FIG. 6, FIG. 6 is an exemplary diagram illustrating a temperature change with respect to time change when a defective battery is charged at a predetermined external temperature, and is a graph derived by an experiment.

At this time, the solid line FL is the actually measured temperature of the battery, and the dotted line DL drawn close to the solid line FL is the reference line. The reference line may be configured by connecting reference values calculated at each diagnosis time point according to the embodiment. Referring to FIGS. 5 and 6, the temperature change of the non-defective battery forms a straight line graph as illustrated in FIG. 5, but the temperature change of the defective battery may form a curve graph as illustrated in FIG. 6.

In the related art, when the temperature of the battery 10 exceeds a fixed reference value (for example, 60° C.), the occurrence of an overheating event is diagnosed at that time point. Referring to FIG. 6, in the related art, overheating of the battery 10 may be diagnosed for the first time at the second time point AD2.

However, according to the overheating diagnosis method according to the embodiment, the occurrence of an overheating event may be diagnosed in advance before the temperature of the battery 10 exceeds a fixed reference value (for example, 60° C.). As a result of the experiment, overheating of the battery 10 was diagnosed for the first time at the first time point AD1. Specifically, as a result of the diagnosis, the overheating event was continuously diagnosed at each diagnosis time point from the first time point AD1 when the solid line FL exceeded the dotted line DL to the second time point AD2.

Referring to FIG. 6, as a result of the experiment, a time difference of about 1000 secs (about 16 minutes) was illustrated between the first time point AD1 and the second time point AD2. According to the method for diagnosing overheating according to the embodiment, it is possible to recognize the occurrence of an overheating event of the battery 10 in advance, so that a countermeasure may be prepared.

While this invention has been described in connection with what is presently considered to be practical exemplary embodiments, it is to be understood that the invention is not limited to the disclosed exemplary embodiments.

1. An overheating diagnosis apparatus, comprising:
a measuring unit configured to measure a temperature of an object;
a storage unit configured to store a plurality of temperature values measured by the measuring unit; and
a control unit configured to, at each diagnosis time point of diagnosing overheating of the object, extract a plurality of previous diagnosis time points corresponding to a predetermined number of samples based on a respective diagnosis time point, calculate a moving average value that is an average of the plurality of temperature values corresponding to a plurality of previous diagnosis time points, respectively, and compare a temperature value measured at each diagnosis time point with a reference value to diagnose the overheating of the object, the reference value being greater than the moving average value by a predetermined value.

2. The overheating diagnosis apparatus of claim 1, wherein the control unit is configured to:
calculate an average standard deviation value, which is an average of a plurality of standard deviations corresponding to the plurality of previous diagnosis time points, respectively,
calculate a first error value by multiplying the average standard deviation value by a predetermined multiple, and
calculate the reference value by adding the first error value to the moving average value.

3. The overheating diagnosis apparatus of claim 2,
wherein when the average standard deviation value is less than a predetermined deviation reference value, the control unit determines a predetermined correction value as a second error value and adds the second error value to the moving average value to calculate the reference value.

4. The overheating diagnosis apparatus of claim 1, wherein when the measured temperature value exceeds the reference value, the control unit diagnoses that an overheating event has occurred in the object.

5. A battery system, comprising;
a battery including a plurality of battery cells;
a measuring unit configured to measure a temperature of the battery;
a storage unit configured to store a plurality of temperature values measured by the measuring unit, and
a control unit configured to, at each diagnosis time point of diagnosing overheating of the battery, extract a plurality of previous diagnosis time points corresponding to a predetermined number of samples based on a respective diagnosis time point, calculate a moving average value that is an average of the plurality of temperature values corresponding to a plurality of previous diagnosis time points, respectively, and compare a temperature value measured at each diagnosis time point with a reference value to diagnose the overheating of the battery, the reference value being greater than the moving average value by a predetermined value.

6. The battery system of claim 5, wherein the control unit is configured to:
calculate an average standard deviation value, which is an average of a plurality of standard deviations corresponding to the plurality of previous diagnosis time points, respectively,
calculate a first error value by multiplying the average standard deviation value by a predetermined multiple, and
calculate the reference value by adding the first error value to the moving average value.

7. The battery system of claim 6, wherein when the average standard deviation value is less than a predetermined deviation reference value, the control unit determines a predetermined correction value as a second error value and adds the second error value to the moving average value to calculate the reference value.

8. The battery system of claim 5, wherein when the measured temperature value exceeds the reference value, the control unit diagnoses that an overheating event has occurred in the battery.

9. An overheating diagnosis method, comprising:
a temperature data collection operation of collecting a temperature value, which is a temperature measurement value of a battery, at a predetermined diagnosis time point for diagnosing overheating of the battery including a plurality of battery cells;
a sample group determination operation of extracting a plurality of previous diagnosis time points corresponding to a number of samples based on the diagnosis time point;
a reference value determination operation of calculating a moving average value, which is an average of a plurality of temperature values corresponding to a plurality of previous diagnosis time points, respectively, and a reference value greater than the moving average value by a predetermined value; and
an overheat diagnosis operation of diagnosing the overheating of the battery by comparing the temperature value with the reference value.

10. The overheating diagnosis method of claim 9, wherein the reference value determination operation includes:
calculating an average standard deviation value, which is an average of standard deviations corresponding to the plurality of pervious diagnosis time points, respectively,
calculating a first error value by multiplying the average standard deviation value by a predetermined multiple, and
calculating the reference value by adding the first error value to the moving average value.

11. The overheating diagnosis method of claim 10, wherein the reference value determination operation includes, when the average standard deviation value is less than a predetermined deviation reference value, determining a predetermined correction value as a second error value and adding the second error value to the moving average value to calculate the reference value.

12. The overheating diagnosis method of claim 9, wherein the overheating diagnosis operation includes, when the measured temperature value exceeds the reference value, diagnosing that an overheating event has occurred in the battery.
